(19) United States
(12) Patent Application Publication
(10) Pub. No.: US 2024/0175311 A1
(43) Pub. Date: May 30, 2024

(54) Door Leaves and Doors Incorporating the Door Leaves

(71) Applicant: QINGDAO SEA NOVA BUILDING PROFILES PRODUCTS CO., LTD., JIAOZHOU CITY (CN)

(72) Inventors: Minghui CHEN, JIAOZHOU CITY (CN); Jianxun ZHANG, JIAOZHOU CITY (CN); Yi CAO, JIAOZHOU CITY (CN); Xuhui WU, JIAOZHOU CITY (CN)

(21) Appl. No.: 18/113,031

(22) Filed: Feb. 22, 2023

(30) Foreign Application Priority Data
Nov. 30, 2022 (CN) 202211521221.4

(51) Int. Cl. E06B 3/16; E06B 3/22

(52) U.S. Cl. CPC E06B 3/16; E06B 3/222

(57) ABSTRACT

A door leaf combinable to form a side-hung door or a sliding door, which includes a frame (1) and a panel (2) disposed in the frame (1). The frame (1) is formed by combining a plurality of universal profiles (3) including a vertically-disposed universal profile and a horizontally-disposed universal profile.

### RELATED APPLICATION

The application claims the benefit of the Chinese Patent Application CN202211521221.4 filed Nov. 30, 2022, which is incorporated herein by reference in its entirety.

### FIELD OF THE INVENTION

The present invention relates to the field of doors and windows of buildings, and in particular, to door leaves and doors incorporating the door leaves.

### BACKGROUND OF THE INVENTION

A door leaf is a door component which can be opened or closed, and is usually applied to spatial isolation and conditional passage between interiors of buildings or between the interior and the exterior of a building. According to different opening and closing modes of doors, common doors include a side-hung door and a sliding door. A door leaf of the side-hung door rotates along a pivot on a vertical edge so as to be opened towards the interior or the exterior, and a door leaf of the sliding door is opened and closed by horizontal movement on a vertical plane in a sliding way.

At present, basic structures of door leaves on the market are quite different according to the different opening and closing modes of doors. That is, the door leaf with the same basic structure cannot be applied to the production and assembly of the side-hung door and the sliding door at the same time to create a universal product. Therefore, additional investments in molds, tools and devices are required, which increases the enterprise cost. Therefore, it is necessary to design a door leaf which can satisfy application requirements of the side-hung door and the sliding door. Further, it is also necessary to lower the difficulty in assembly as much as possible to simplify an assembling process, increase the production efficiency and reduce the cost.

### OBJECTS AND SUMMARY OF THE INVENTION

For the above-mentioned problems, the present invention discloses door leaves and doors incorporating the door leaves.

Specific technical solutions are as follows.

A door leaf includes a frame and a panel which fits in the frame, wherein the frame is formed by connecting a plurality of universal profiles, and the universal profile is provided with a plurality of component slots for connecting an auxiliary profile and for assembling a door-leaf accessory.

The universal profile includes a profile main body, a plurality of inner-side outer edges which extend to two ends of the profile main body and a plurality of outer-side outer edges which extend to two ends of the profile main body. The profile main body has a hollow cross section. The inner-side outer edge has a hollow cross section. The outer-side outer edge has a hollow cross section. The plurality of inner-side outer edges, which are symmetrically configured, and an end surface on one side of the profile main body form an inner-side mounting channel. The plurality of outer-side outer edges, which are symmetrically configured, and an end surface on another side of the profile main body form an outer-side mounting channel. An inner side surface of the inner-side outer edge is symmetrically provided with a component slot. An inner side surface of the outer-side outer edge is symmetrically provided with a component slot.

In an embodiment, a cross section of the profile main body is a rectangle. The rectangle's diagonals intersect at a central point O-1 of the profile main body. A line of symmetry L-1 of the universal profile passes through the central point O-1. A plurality of first reinforcement ribs, which are symmetric with respect to the line of symmetry L-1, are configured inside the profile main body. A hollow space within the profile main body is compartmentalized, by the plurality of first reinforcement ribs, into two symmetric first cavities and a second cavity sandwiched by the two first cavities. The plurality of outer-side outer edges are symmetrically configured with respect to the line of symmetry L-1. A plurality of second reinforcement ribs are symmetrically configured inside a hollow space within the plurality of outer-side outer edges. The hollow space within the outer-side outer edge is compartmentalized, by the second reinforcement rib, into a third cavity and a fourth cavity adjacent to the third cavity. A fifth cavity is configured in a hollow space in the inner-side outer edge.

The first reinforcement rib is disposed in parallel to the line of symmetry L-1. A plane on which the second reinforcement rib is located is perpendicular to the line of symmetry L-1. A cross-sectional area of the second cavity is greater than a cross-sectional area of any one of the first cavity, the third cavity, the fourth cavity and the fifth cavity.

A first depth along a direction in which an opening position of the inner-side mounting channel extends to the central point O-1 is a depth of the inner-side mounting channel. A second depth along a direction in which an opening position of the outer-side mounting channel extends to the central point O-1 is a depth of the outer-side mounting channel. The first depth is less than the second depth. The second reinforcement rib is located at a central position on the outer-side outer edge. the outer-side mounting channel is divided into an outer-side mounting channel outer end and an outer-side mounting channel inner end by the plane on which the second reinforcement rib is located; a width of the outer-side mounting channel outer end is greater than a width of the outer-side mounting channel inner end; and the outer-side mounting channel outer end and the outer-side mounting channel inner end are connected by an oblique transition segment whose obliqueness transitions smoothly.

According to the above-mentioned door leaf, a cross section of the profile main body is a rectangle, wherein the rectangle's diagonals intersect at a central point O-2 of the profile main body. A line of symmetry L-2 of the universal profile passes through the central point O-2. The inner-side outer edge and the outer-side outer edge which is on the same side as the inner-side outer edge are interconnected and communicating. A hollow structure formed by the inner-side outer edge and the outer-side outer edge is compartmentalized into a plurality of cavities by a plurality of third reinforcement ribs.

The inner-side mounting channel is internally provided with a first bottom plate. The outer-side mounting channel is internally provided with a second bottom plate. The first bottom plate, which is spaced apart from and disposed in parallel to one side of the profile main body, forms a sixth cavity. The second bottom plate, which is disposed on an other side of the profile main body, forms a seventh cavity.

The second bottom plate, a middle portion of which bends towards the profile main body, is connected with a side of the profile main body to form an integrated piece with profile main body. The integrated piece divides the seventh cavity into two independent cavities. The two independent cavities formed by the seventh cavity are symmetrically disposed with respect to the line of symmetry L-2.

In an embodiment, a plurality of centerline grooves are formed in a middle portion of an end surface on two sides of the universal profile. The plurality of centerline grooves include a first centerline groove and a second centerline groove. The first centerline groove is configured on the inner-side mounting channel. The second centerline groove is configured on the outer-side mounting channel.

In an embodiment, a reinforced steel is built into the profile main body of the universal profile for improving structural strength. The component slot in the inner-side outer edge of the universal profile has a trapezoidal cross section. A rubber sealing strip is affixed onto the component slot. The component slot in the outer-side outer edge of the universal profile has an L-shaped or T-shaped cross section. The rubber sealing strip is used for crimping and sealing the panel.

A side-hung door includes a side-hung door frame and a pair of door leaves for connecting to and for matching the side-hung door frame. A side of the door leaf is hinged to the side-hung door frame through a hinge. The frame is formed by combining a pair of the horizontally-disposed universal profiles and a pair of the vertically-disposed universal profiles. The panel is mounted into the frame through the inner-side mounting channel. The horizontally-disposed universal profile and the vertically-disposed universal profile connect at a right angle.

The outer-side outer edge of the horizontally-disposed universal profile is in clamping connection to a leaf-edge sealing cover plate through a component slot. The outer-side outer edge of the universal profile which is hinged to the side-hung door frame is in clamping connection to a leaf-edge sealing cover plate through a component slot.

In an embodiment, the side-hung door includes a matching pair of the door leaves. A pair of the outer-side outer edges on the universal profiles of the matching pair of the door leaves are meant to meet each other when the side-hung door is closed. A first one of the pair of the outer-side outer edges is connected to a leaf-edge sealing cover plate through a component slot that is provided on the first one of the pair of the outer-side outer edges. A second one of the pair of the outer-side outer edges is connected to a astragal through a component slot that is provided on the second one of the pair of the outer-side outer edges. The leaf-edge sealing cover plate is in clamping connection with the universal profile. A middle portion of the leaf-edge sealing cover plate is provided with a side-hung door lock. The astragal is fixedly screwed to the door leaf; and a middle portion of the astragal is provided with a universal latch to match the side-hung door lock.

In an embodiment, a side of a bottom of the side-hung door frame is provided with a cover. An elastic sealing strip is provided on a side surface of the cover which is adjacent to the door leaf.

A sliding door includes a sliding door frame and a plurality of the door leaves which are in sliding fit with the sliding door frame. The door leaf is slidably disposed on the sliding door frame. The frame is formed by combining a pair of the horizontally-disposed universal profiles and a pair of the vertically-disposed universal profiles. The panel is mounted into the frame through the outer-side mounting channel.

A top portion of the sliding door frame is provided with a limiting track which faces vertically downwards. The outer-side outer edge of the horizontally-disposed universal profile, which is on an upper end of the door leaf, is provided with a limiting channel to match the limiting track. The limiting channel, which is mounted in the outer-side mounting channel, is in sliding fit with the limiting track.

A bottom portion of the sliding door frame is provided with a sliding track which faces vertically upwards. The outer-side outer edge of the horizontally-disposed universal profile, which is on a lower end of the door leaf, is provided with a plurality of rollers to match the sliding track. The plurality of rollers, which are mounted in the outer-side mounting channel, are in sliding fit with the sliding track.

In an embodiment, a portion of the vertically-disposed universal profile which engages the sliding door frame when the sliding door is closed is in clamping connection with a leaf-edge sealing cover plate through a component slot. A portion of the vertically-disposed universal profile which engages a vertically-disposed universal profile of an adjacent door leaf when the sliding door is closed is in clamping connection with a limiting profile through a component slot. The limiting profile, which is L-shaped, includes an end cap which is in clamping connection with a component slot and a limiting strip which extends to a gap between an adjacent pair of the door leaves. The end cap and the limiting strip are configured on an integrated piece. A pair of the limiting profiles between the adjacent pair of the door leaves work together to control the adjacent pair of the door leaves to slide synchronously. The limiting strip is provided with a specialized component slot. The limiting strip is connected to a first sealing strip and to a second sealing strip through the specialized component slot. The first sealing strip faces towards the adjacent pair of the door leaves. The second sealing strip, which faces towards the limiting profile, seals a gap between the pair of the limiting profiles.

In an embodiment, a third sealing strip is in clamping connection with a component slot on the outer-side outer edge of the universal profile on the top portion of the sliding door frame. The third sealing strip fits the limiting track for sealing purposes. A fourth sealing strip is in clamping connection with a component slot on the outer-side outer edge of the universal profile on the bottom portion of the sliding door frame. The fourth sealing strip fits the sliding track for sealing purposes.

In an embodiment, a cover is provided on one side of the bottom portion of the sliding door frame. The cover is provided with a guide rail for guiding a sliding screen door leaf.

The present invention has the beneficial effects.

Our invention, which relates to the field of doors and windows of buildings, discloses a door leaf and a door that incorporates the door leaf. The door leaf includes a frame and a panel. The frame is formed by connecting a plurality of universal profiles. The universal profile includes a profile main body, a plurality of inner-side outer edges and a plurality of outer-side outer edges. Also, a plurality of component slots are provided for the universal profile. The door leaf disclosed by the present invention satisfies application requirements of side-hung doors and sliding doors. Our new door leaf reduces upfront costs for molds, tools and devices. It simplifies machining and assembling processes. It increases efficiency and reduces the cost. The side-hung door and the sliding door which incorporate the new door leaf will be stable in structure and perfect in function.

### BRIEF DESCRIPTION OF FIGURES

FIG. 1 is an elevation view of the door leaf (threaded door leaf);

FIG. 2 is an exploded view of the door leaf (threaded door leaf);

FIG. 3 is a sectional view of the vertically-disposed universal profile;

FIG. 4 is a sectional view of the horizontally-disposed universal profile;

FIG. 5 is an elevation view of the door leaf (welded door leaf);

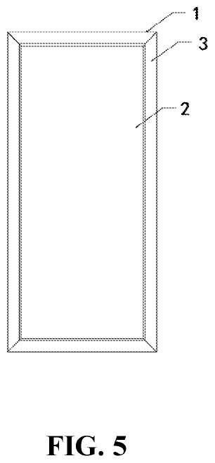

FIG. 6 is a sectional view of the universal profile (welded leaf profile);

FIG. 7 is a schematic view of the mounting position of a reinforced corner piece;

FIG. 8 is an outer elevation view of the side-hung door;

FIG. 9 is a longitudinal sectional view of the side-hung door with a narrow frame;

FIG. 10 is a cross sectional view of the double-leaf side-hung door;

FIG. 11 is a cross sectional view of the side-hung door frame and a door leaf in a connected state;

FIG. 12 is an inner elevation view of the double-leaf side-hung door with a single leaf openable (narrow-side leaf unopened);

FIG. 13 is an inner elevation view of the double-leaf side-hung door with a single leaf openable (equal-width leaf unopened);

FIG. 14 is a longitudinal sectional view of the side-hung door with a wide frame;

FIG. 15 is a longitudinal sectional view of the fixed door leaf and a side-hung door frame;

FIG. 16 is a cross sectional view of the double-leaf side-hung door with a single leaf openable;

FIG. 17 is an inner elevation view of the sliding door;

FIG. 18 is a longitudinal sectional view of the sliding door;

FIG. 19 is a cross sectional view of the sliding door;

FIG. 20 is a sectional view of the limiting profile;

FIG. 21 is an inner elevation view of a sliding door (with three door leaves); and

FIG. 22 is an inner elevation view of a sliding door (with four door leaves).

Reference numerals: 1) frame; 2) panel; 3) universal profile; 4) component slot; 5) profile main body; 6) inner-side outer edge; 7) outer-side outer edge; 8) inner-side mounting channel; 9) outer-side mounting channel; 10) first centerline groove; 11) first centerline groove; 12) reinforcement rib; 13) connecting hollow; 14) side-hung door frame; 15) hinge; 16) leaf-edge sealing cover plate; 17) astragal; 18) side-hung door lock; 19) universal latch; 20) cover; 21) elastic sealing strip; 22) sliding door frame; 23) limiting track; 24) limiting channel; 25) sliding track; 26) roller; 27) limiting profile; 28) end cap; 29) limiting strip; 30) first sealing strip; 31) second sealing strip; 32) third sealing strip; 33) fourth sealing strip; 34) reinforced steel; 35) rubber sealing strip; 36) reinforced corner piece; 39) clamping strip; 40) clamping slot; 41) operable door leaf; 42) fixed door leaf; 43) mullion; 51) first reinforcement rib; 52) second reinforcement rib; 53) third reinforcement rib; 61) first cavity; 62) second cavity; 63) third cavity; 64) fourth cavity; 65) fifth cavity; 66) sixth cavity; 67) seventh cavity; 91) outer-side mounting channel outer end; 92) outer-side mounting channel inner end; 93) transition segment; 94) first bottom plate and 95) second bottom plate.

### DETAILED DESCRIPTION OF THE EMBODIMENTS

In order to make the technical solutions of the present invention clearer, the present invention will be further described below in conjunction with embodiments. Any solutions obtained by equivalently substituting and conventionally reasoning the technical features of the technical solutions of the present invention fall into the protection scope of the present invention.

### Embodiment 1

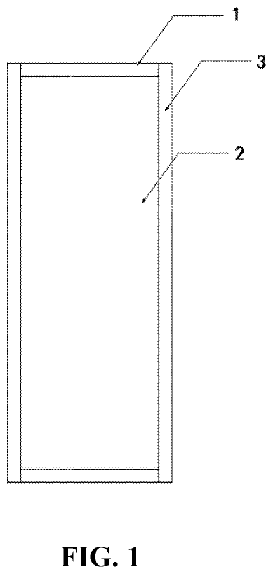

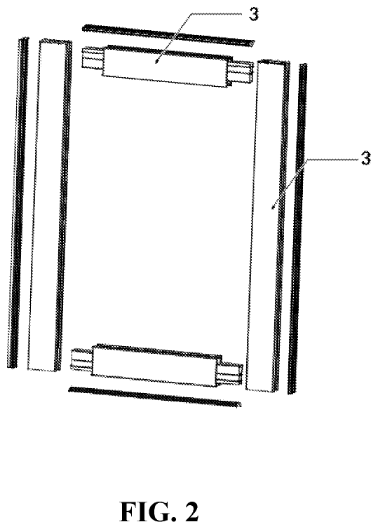

As shown in FIGS. 1 to 4, the present embodiment discloses a door leaf applicable to the universal mounting of a side-hung door and a sliding door. Specifically, the door leaf includes a frame 1 and a panel 2 which fits in the frame 1. The frame 1 is formed by connecting a plurality of universal profiles 3. The universal profile 3 is provided with a plurality of component slots 4 for connecting an auxiliary profile and for assembling a door-leaf accessory. The universal profiles 3 in the present embodiment have the characteristic of universality and can be adaptively equipped with most of auxiliary profiles and door-leaf accessories, thereby achieving the universal mounting of the side-hung door and the sliding door.

The universal profile 3 in the present embodiment includes a profile main body 5, a plurality of inner-side outer edges 6 which extend to two ends of the profile main body 5 and a plurality of outer-side outer edges 7 which extend to two ends of the profile main body 5. To reduce the production cost and satisfy a requirement for lightweight, the profile main body 5 has a hollow cross section. The inner-side outer edge 6 has a hollow cross section. The outer-side outer edge 7 has a hollow cross section, with reinforcement ribs 12 configured therein to improve the structural strength thereof.

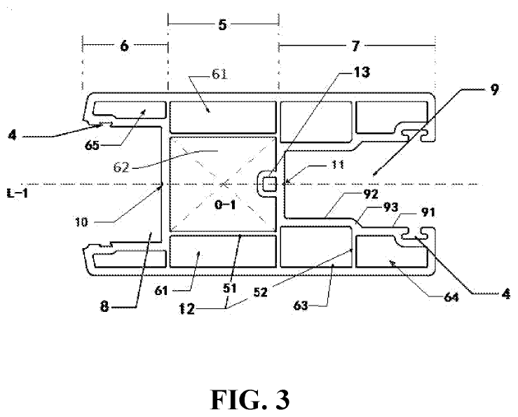

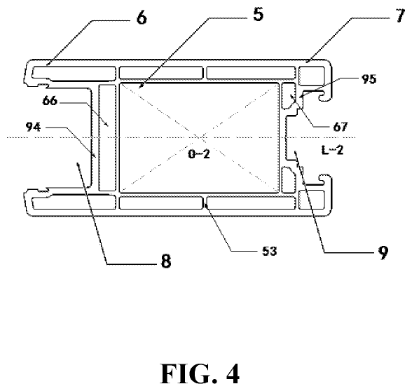

As shown in FIGS. 3 and 4, the plurality of inner-side outer edges 6, which are symmetrically configured, and an end surface (an end surface on the left as shown in FIGS. 3 and 4) on one side of the profile main body 5 form an inner-side mounting channel 8 which can be used for assembling various auxiliary profiles. Similarly, the plurality of outer-side outer edges 7, which are also symmetrically configured, and an end surface (an end surface on the right as shown in FIGS. 3 and 4) on another side of the profile main body 5 form an outer-side mounting channel 9. Furthermore, an inner side surface of the inner-side outer edge 6 is symmetrically provided with a component slot 4. An inner side surface of the outer-side outer edge 7 is symmetrically provided with a component slot 4. The component slot 4 is used for mounting and assembling the various corresponding auxiliary profiles and door-leaf accessories.

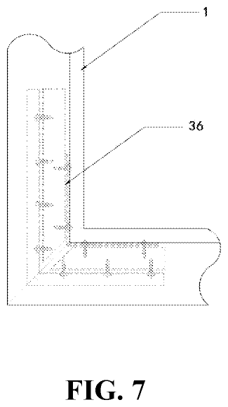

The universal profiles in the present embodiment may be made of a metal (such as aluminum alloy and stainless steel) and may also be made of thermoplastic plastics. When being combined to form the frame 1, the plurality of universal profiles 3 may be connected in a threaded connection or welding (metal welding and hot-melt welding) way and may be reinforced in a way of additionally mounting or placing reinforced corner pieces 36 (inner reinforced corner pieces and/or outer reinforced corner pieces) on inner or outer edges of four corners of the frame 1 (as shown in FIG. 7).

As shown in a sectional view of a universal profile in FIG. 3, widths (horizontal lengths in FIG. 3) and heights (vertical lengths in FIG. 3) of the profile main body 5, the inner-side outer edges 6 and the outer-side outer edges 7 can be adjusted according to actual requirements. The universal profiles 3 in the present embodiment are used for assembling the door leaf and can be adaptively assembled with the auxiliary profile and the door-leaf accessory with the component slots 4, thereby satisfying application requirements of the side-hung door and the sliding door.

### Embodiment 2

As shown in FIG. 3, the present embodiment discloses a door leaf in which a cross section of the profile main body 5 is a rectangle. The rectangle's diagonals intersect at a central point O-1 of the profile main body 5. A line of symmetry L-1 of the universal profile 3 passes through the central point O-1. A plurality of first reinforcement ribs 51, which are symmetric with respect to the line of symmetry L-1, are configured inside the profile main body 5. The plurality of outer-side outer edges 7 are symmetrically configured with respect to the line of symmetry L-1. A plurality of second reinforcement ribs 52 are symmetrically configured inside a hollow space within the plurality of outer-side outer edges 7 so that profile structures of the profile main body 5 and the outer-side outer edges 7 are reinforced. A hollow space within the profile main body 5 is compartmentalized, by the plurality of first reinforcement ribs 51, into two symmetric first cavities 61 and a second cavity 62 sandwiched by the two first cavities 61. The hollow space within the outer-side outer edge 7 is compartmentalized, by the second reinforcement rib 52, into a third cavity 63 and a fourth cavity 64 adjacent to the third cavity 63. A fifth cavity 65 is configured in a hollow space in the inner-side outer edge 6.

The first reinforcement ribs 51 are disposed in parallel to the line of symmetry L-1. A plane on which the second reinforcement rib 52 is located is perpendicular to the line of symmetry L-1. The reinforcement ribs in the universal profiles 3 are distributed vertically and horizontally, so as to guarantee the structural strength of the universal profiles 3 in a plurality of directions. A cross-sectional area of the second cavity 62 is greater than a cross-sectional area of any one of the first cavity 61, the third cavity 63, the fourth cavity 64 and the fifth cavity 65.

In an embodiment, a first depth along a direction in which an opening position of the inner-side mounting channel 8 extends to the central point O-1 is a depth of the inner-side mounting channel 8. A second depth along a direction in which an opening position of the outer-side mounting channel 9 extends to the central point O-1 is a depth of the outer-side mounting channel 9. It can be seen from the figure that the first depth is less than the second depth. Therefore, no reinforcement ribs are disposed in the inner-side outer edges. Moreover, the second reinforcement rib 52 is located at a central position on the outer-side outer edge 7, so that the structural strength and stability of the outer-side outer edge 7 are improved evenly. Furthermore, the outer-side mounting channel 9 is divided into an outer-side mounting channel outer end 91 and an outer-side mounting channel inner end 92 by the plane on which the second reinforcement rib 52 is located. A width of the outer-side mounting channel outer end 91 is greater than a width of the outer-side mounting channel inner end 92. The outer-side mounting channel outer end 91 and the outer-side mounting channel inner end 92 are connected by an oblique transition segment 93 whose obliqueness transitions smoothly. This structural feature not only lies in satisfying a design requirement for the profiles but positions where the profiles match the second reinforcement ribs 52 can be beneficial to reinforce the structural strength of the outer-side mounting channel 9.

### Embodiment 3

In an embodiment shown in FIG. 4, a cross section of the profile main body 5 in the door leaf is a rectangle. The rectangle's diagonals intersect at a central point O-2 of the profile main body 5. A line of symmetry L-2 of the universal profile 3 passes through the central point O-2. The inner-side outer edge 6 and the outer-side outer edge 7 which is on the same side as the inner-side outer edge 6 are interconnected and communicating. A hollow structure formed by the inner-side outer edge 6 and the outer-side outer edge 7 is compartmentalized into a plurality of chambers by a plurality of third reinforcement ribs 53.

The inner-side mounting channel 8 is internally provided with a first bottom plate 94, and the outer-side mounting channel 9 is internally provided with a second bottom plate 95. The first bottom plate 94, which is spaced apart from and disposed in parallel to one side of the profile main body 5, forms a sixth cavity 66. The second bottom plate 95, which is disposed on another side of the profile main body 5, forms a seventh cavity 67.

The second bottom plate 95, a middle portion of which bends towards the profile main body 5, is connected with a side of the profile main body 5 to form an integrated piece with the profile main body 5. The integrated piece divides the seventh cavity 67 into two independent cavities. The two independent cavities formed by the seventh cavity 67 are symmetrically disposed with respect to the line of symmetry L-2.

### Embodiment 4

In an embodiment of the door leaf shown in FIG. 3, a plurality of centerline grooves are formed in a middle portion of an end surface on two sides of the universal profile 3. The plurality of centerline grooves include a first centerline groove 10 and a first centerline groove 11. The first centerline groove 10 is configured on the inner-side mounting channel 8. The first centerline groove 11 is configured on the outer-side mounting channel 9. Such configuration functions for positioning of riveting points, so that screws can be more easily screwed in the universal profiles 3 when the auxiliary profile is connected or the door-leaf accessory is assembled later. So difficulty in assembly is mitigated.

### Embodiment 5

An embodiment of the door leaf is shown in a sectional view of a universal profile in FIGS. 3 and 4. In the case that the universal profiles 3 have the same length and width, the width of the outer-side outer edge 7 in FIG. 3 is obviously greater than the width of the outer-side outer edge 7 in FIG. 4. The depth of the outer-side mounting channel 9 in FIG. 3 is obviously greater than the depth of the outer-side mounting channel 9 in FIG. 4. This is so because the universal profile 3 in FIG. 3 is mainly used as a vertically-disposed universal profile which is usually mounted on the left or right side of the frame 1 and is vertically disposed. The widened outer-side outer edges 7 and the deepened outer-side mounting channel 9 are more beneficial to the assembly of the door-leaf accessory such as a door lock. Of course, it can also be used as a horizontally-disposed universal profile. In contrast, the universal profile 3 in FIG. 4 is mostly used as a horizontally-disposed universal profile which is usually mounted on the upper or lower side of the frame 1 and is horizontally disposed. The outer-side outer edges 7 and the outer-side mounting channel 9 are better suitable for the assembly of such components as auxiliary profile for sealing dust prevention.

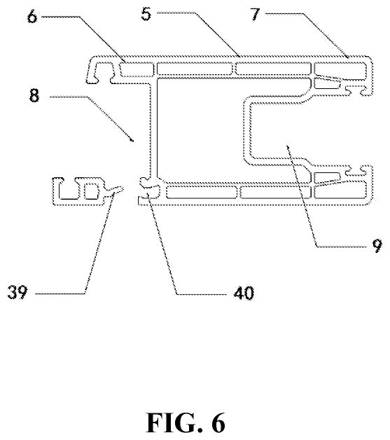

FIGS. 3 and 6 show a sectional view of a universal profile. The universal profiles 3 have the same length and width. The inner-side outer edges 6 of the universal profile 3 in FIG. 6 are combinable and are detachably mounted. A side of the inner-side outer edge 6 which faces the profile main body 5 includes a clamping strip. The profile main body 5 includes a clamping slot to match the clamping strip. The inner-side outer edge 6 is detachably connected to the profile main body 5 by clamping connection between the clamping strip and the clamping slot. When the universal profile 3 in FIG. 6 is used as a vertically-disposed universal profile or a horizontally-disposed universal profile, the panel 2 disposed in the frame 1 is convenient to mount, dismount and replace. It is also easy to clean, care and maintain the door leaf.

### Embodiment 6

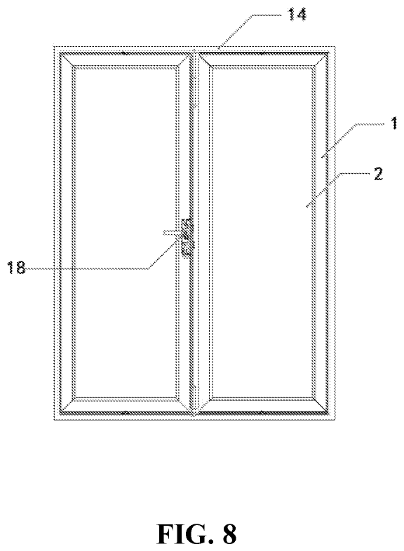

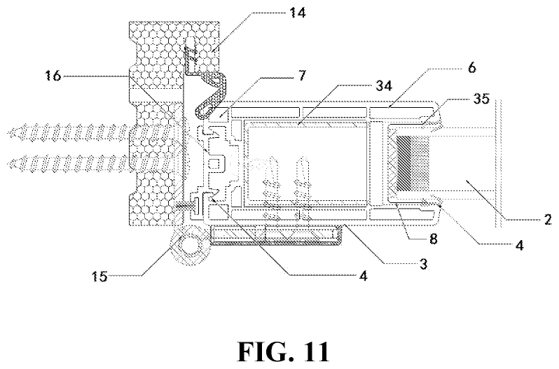

As shown in FIGS. 8 to 11, the side-hung door includes a side-hung door frame 14 and a pair of door leaves for connecting to and for matching the side-hung door frame 14. The universal door leaves have the technical features in embodiment 1 and embodiment 5 and are applicable to the combined mounting of the side-hung door.

Specifically, a side of the door leaf is hinged to the side-hung door frame 14 through a hinge 15. The frame 1 is designed to be shaped like a frame and is formed by combining a pair of the horizontally-disposed universal profiles 3 and a pair of the vertically-disposed universal profiles 3. The panel 2 is mounted into the frame 1 through the inner-side mounting channel 8.

The outer-side outer edge 7 of the horizontally-disposed universal profile 3 is in clamping connection to a leaf-edge sealing cover plate 16 through a component slot 4 so that the upper and lower sides of a side-hung door leaf are sealed. The outer-side outer edge 7 of the universal profile 3 which is hinged to the side-hung door frame 14 is in clamping connection to a leaf-edge sealing cover plate 16 through a component slot 4 so that the side of the side-hung door leaf which meets the door frame when the door is closed is well sealed.

To achieve an opening/closing function of the side-hung door, the side-hung door includes a matching pair of the door leaves. A pair of the outer-side outer edges 7 on the universal profiles 3 of the matching pair of the door leaves are meant to meet each other when the side-hung door is closed. A first one of the pair of the outer-side outer edges 7 is connected to a leaf-edge sealing cover plate 16 through a component slot 4 that is provided on the first one of the pair of the outer-side outer edges 7. A second one of the pair of the outer-side outer edges 7 is connected to a astragal 17 through a component slot 4 that is provided on the second one of the pair of the outer-side outer edges 7. The leaf-edge sealing cover plate 16 is in clamping connection with the universal profile 3 through a component slot 4 and is screwed. A middle portion of the leaf-edge sealing cover plate 16 is provided with a side-hung door lock 18. The astragal 17 is fixedly screwed to the door leaf. A middle portion of the astragal 17 is provided with a universal latch 19 to match the side-hung door lock 18.

So far, door frame connection, side seal and opening/closing accessory assembly for the side-hung door in the present embodiment are completed. The universal combined mounting of the side-hung door is achieved.

### Embodiment 7

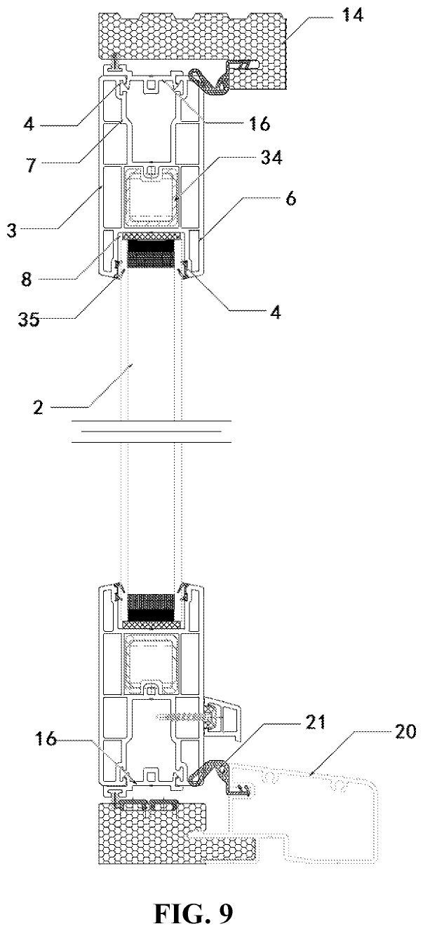

Based on embodiment 6, the present embodiment provides a side-hung door, in which a bottom of an outdoor side (the right shown in FIG. 9) of the side-hung door frame 14 is provided with a cover 20. An elastic sealing strip 21 is provided on a side surface of the cover 20 which is adjacent to the door leaf.

### Embodiment 8

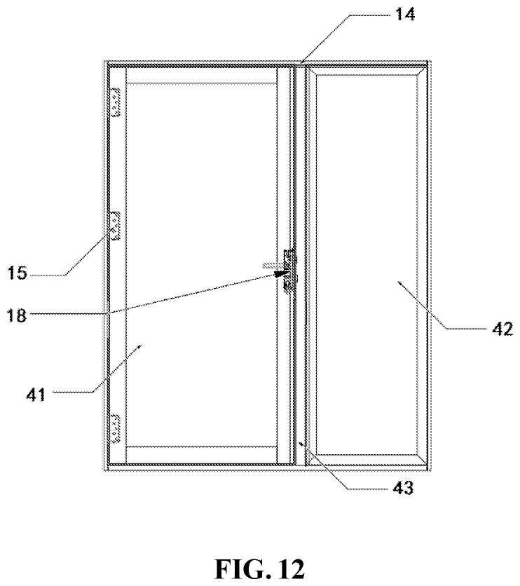

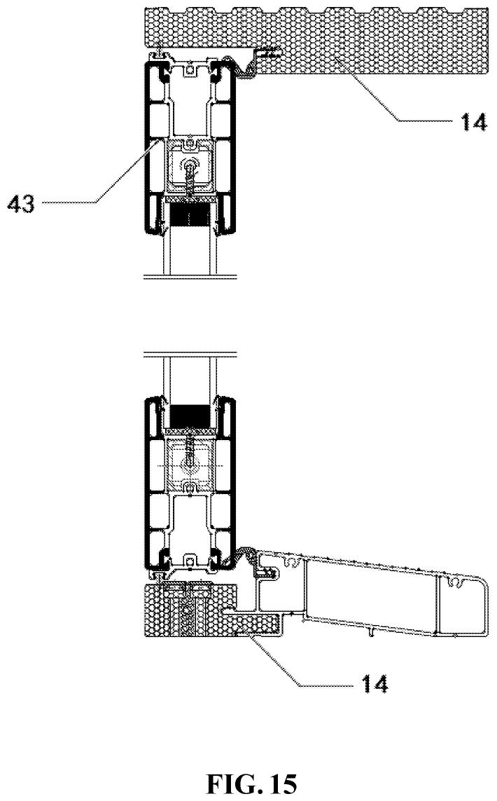

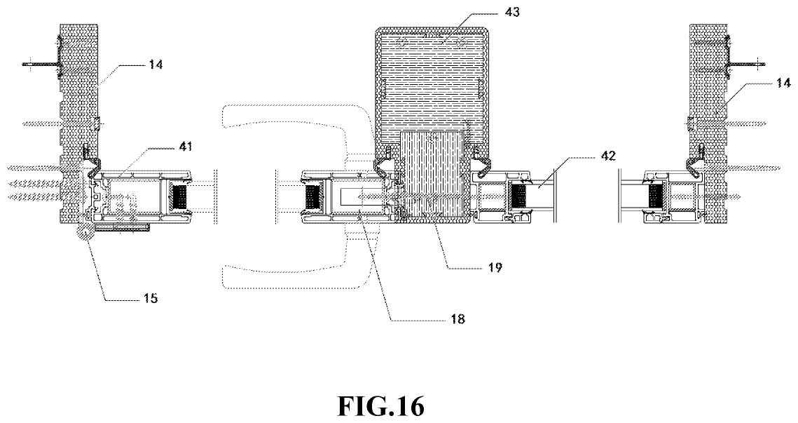

As shown in FIGS. 12 to 16, the present embodiment discloses a side-hung door which is a single-sided leaf opened side-hung door. In a pair of universal door leaves, one door leaf is fixed, and the other door leaf can be freely opened or closed. The pair of universal door leaves include an operable door leaf 41 which can be openable/closable and a fixed door leaf 42. The side-hung door frame 14 is internally provided with a vertically-disposed mullion 43. Upper and lower ends of the mullion 43 are fixedly connected to the side-hung door frame 14. The inside of the side-hung door frame 14 is segmented into two mounting areas in which the operable door leaf 41 and the fixed door leaf 42 are respectively mounted.

An end of the operable door leaf 41 is in hinged connection to the side-hung door frame 14 through a hinge 15. The other end of the operable door leaf 41 is equipped with a side-hung door lock 18. The fixed door leaf 42 is riveted and fixed to the side-hung door frame 14 and to the mullion 43 through screws. The side of the mullion 43 which faces to the operable door leaf includes a universal latch 19 to match the side-hung door lock 18.

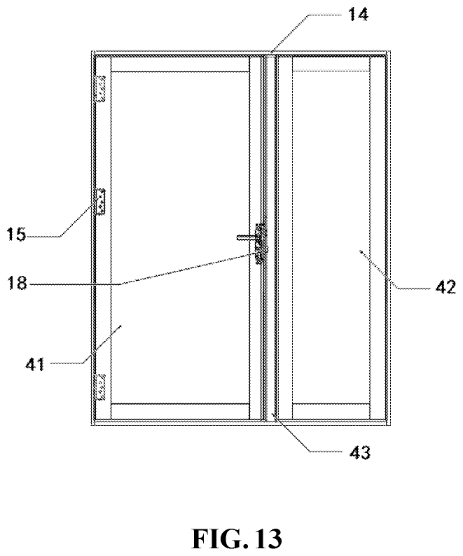

As shown in FIGS. 12 and 13, the relationship between the widths of the frames of the operable door leaf 41 and the fixed door leaf 42 is customizable. The side-hung doors may be categorized into narrow-side leaf unopened side-hung doors (as shown in FIG. 12) and equal-width leaf unopened side-hung doors (as shown in FIG. 13).

### Embodiment 9

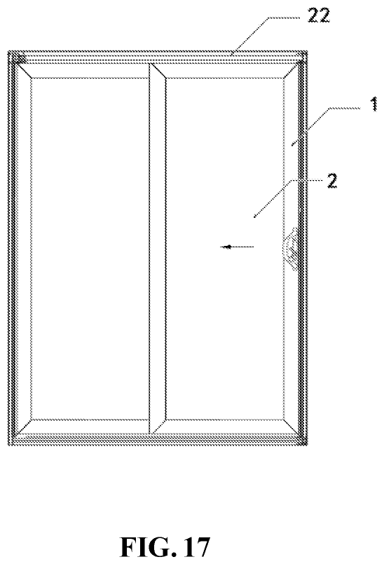

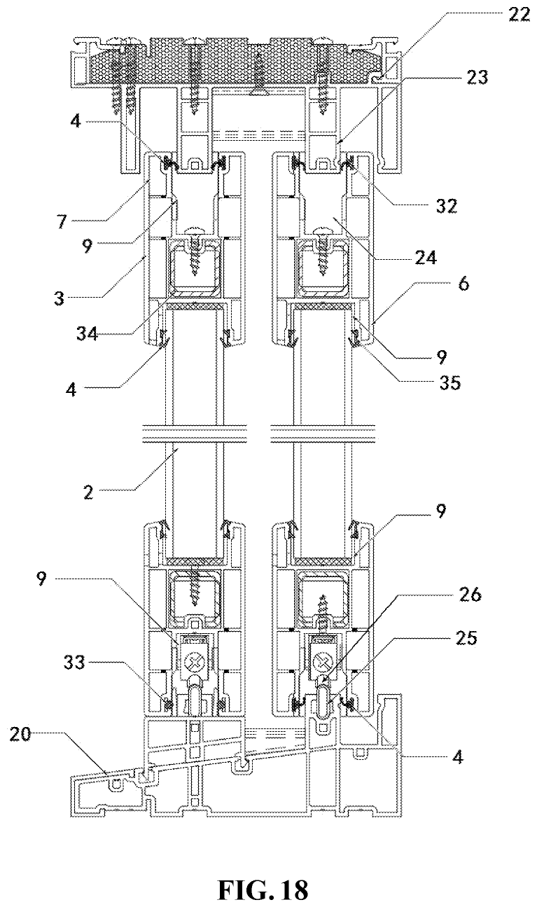

FIGS. 17 to 21 illustrate an embodiment of the sliding door. This sliding door includes a sliding door frame 22 and a plurality of the universal door leaves which are in sliding fit with the sliding door frame 22. The universal door leaves have the technical features in embodiment 1 and embodiment 4 and are applicable to the combined mounting of the sliding door.

The universal door leaf is slidably disposed on the sliding door frame 22. The frame 1, which is shaped like an outlining structure, is formed by combining a pair of horizontally-disposed universal profiles 3 and a pair of vertically-disposed universal profiles 3. The panel 2 is mounted onto the frame 1 through the outer-side mounting channel 9.

A top portion of the sliding door frame 22 is provided with a limiting track 23 which faces vertically downwards. Cooperatively, in the present embodiment, the outer-side outer edge 7 of the horizontally-disposed universal profile 3, which is on an upper end of the door leaf, is provided with a limiting channel 24 to match the limiting track 23; the limiting channel 24, which is mounted in the outer-side mounting channel 9, is in sliding fit with the limiting track 23, thereby achieving limiting and sliding fit on the upper end of the universal door leaf.

A bottom portion of the sliding door frame 22 includes a sliding track 25 which faces vertically upwards. Cooperatively, the outer-side outer edge 7 of the horizontally-disposed universal profile 3, which is on a lower end of the door leaf, is provided with a plurality of rollers 26 to match the sliding track 25. The plurality of rollers 26, which are mounted in the outer-side mounting channel 9, are in sliding fit with the sliding track 25, thereby achieving limiting and sliding fit on the lower end of the universal door leaf.

So far, the sliding fit between the sliding door frame 22 and the universal door leaf of the sliding door in the present embodiment is attained.

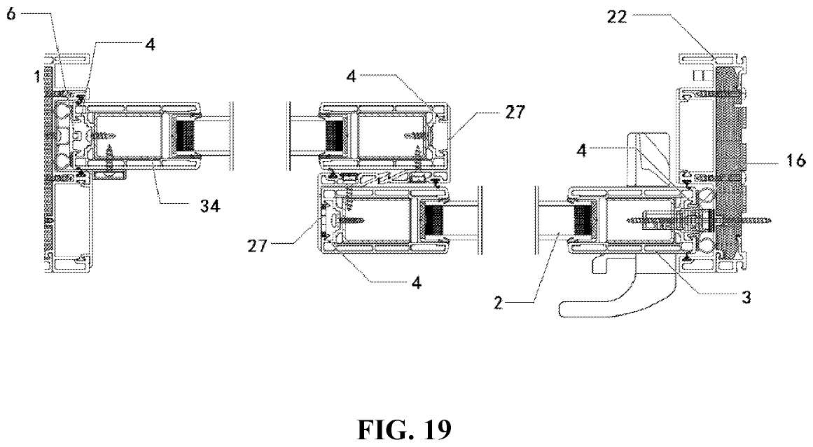

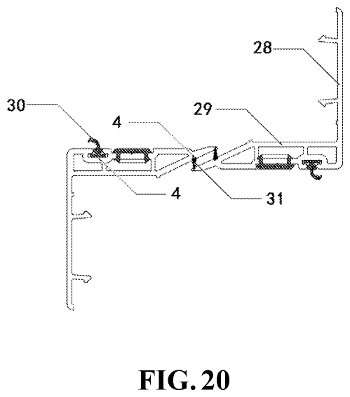

As shown in FIGS. 19 and 20, a portion of the vertically-disposed universal profile 3 which engages the sliding door frame 22 when the sliding door is closed is further provided with a leaf-edge sealing cover plate 16 which is in clamping connection with the universal profile 3 through a component slot 4. A portion of the vertically-disposed universal profile 3 which engages a vertically-disposed universal profile of an adjacent door leaf when the sliding door is closed is provided with a limiting profile which is in clamping connection with the universal profile 3 through a component slot 4.

The limiting profile 27, which is L-shaped, includes an end cap 28 which is in clamping connection with a component slot 4 and a limiting strip 29 which extends to a gap between an adjacent pair of the door leaves. The end cap 28 is used for sealing a side of the universal profile 3. The limiting strip 29 is used for limitation and one-way synchronization between the adjacent universal door leaves to enable a pair of the limiting profiles 27 between the adjacent pair of the door leaves to work together to control the adjacent pair of the door leaves to slide synchronously when the universal door leaves are closed, thereby achieving a one-way synchronous movement effect. The end cap 28 and the limiting strip 29 are configured on an integrated piece and are universal auxiliary profiles. The limiting strip 29 is provided with a specialized component slot 4 and is connected to a first sealing strip 30 and to a second sealing strip 31 through the specialized component slot 4. The first sealing strip 30 faces towards the adjacent pair of the door leaves. The second sealing strip 31, which faces towards the limiting profile 27, seals a gap between the pair of the limiting profiles 27. When the sliding door is in a closed state, a good sealing effect will be achieved between the adjacent universal door leaves.

A third sealing strip 32 is in clamping connection with a component slot 4 on the outer-side outer edge 7 of the universal profile 3 on the top portion of the sliding door frame 22. A fourth sealing strip 33 is in clamping connection with a component slot 4 on the outer-side outer edge 7 of the universal profile 3 on the bottom portion of the sliding door frame 22. The third sealing strip 32 fits the limiting track 23 for sealing purposes. The fourth sealing strip 33 fits the sliding track 25 for sealing purposes. Therefore, the sealing between the sliding door frame 22 and the universal door leaf is attained.

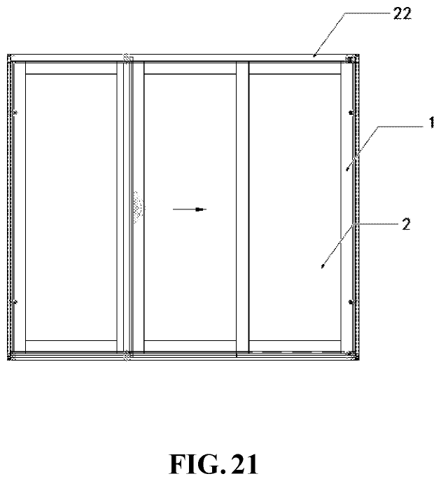

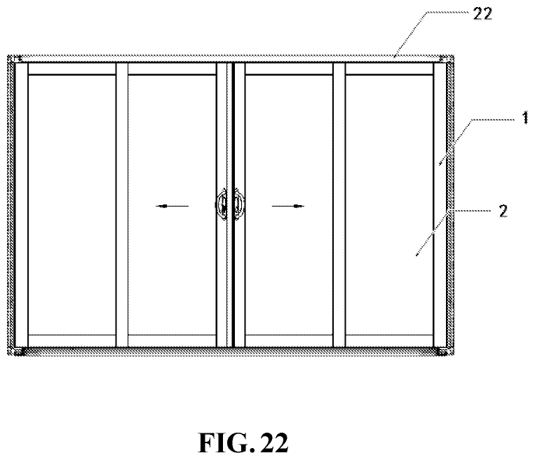

So far, in the present embodiment, the universal combined mounting of the sliding door is attained. The number of the door leaves of the sliding door in the present embodiment can be adjusted according to practical conditions. For example, the sliding door may be a sliding door with three door leaves as shown in FIG. 21 or a sliding door with four door leaves as shown in FIG. 22.

### Embodiment 10

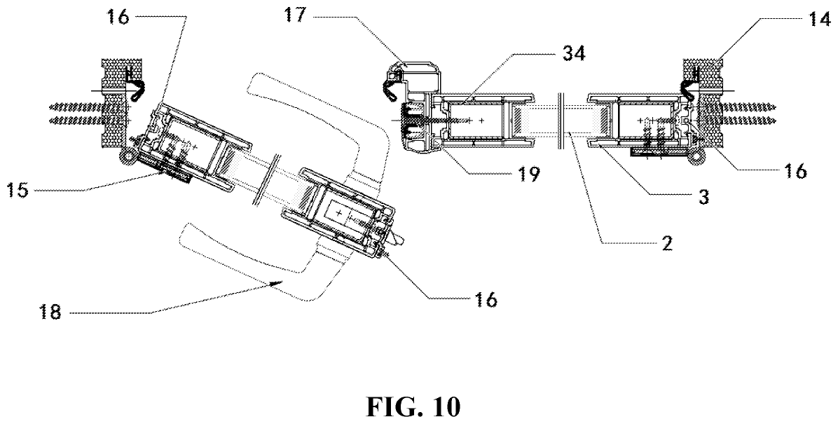

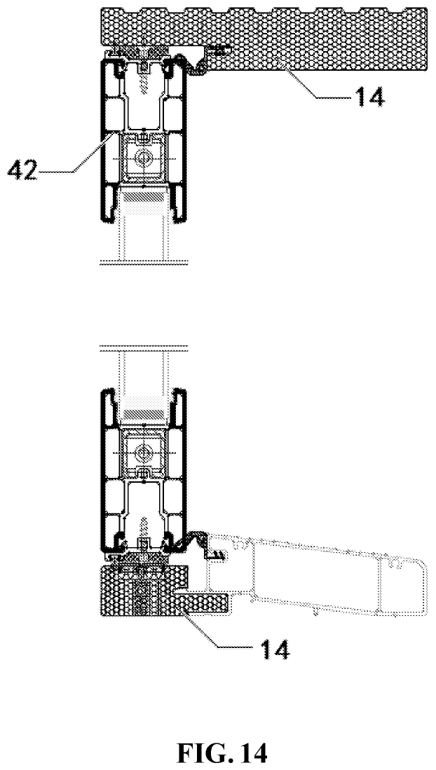

As shown in FIG. 10, based on embodiment 7 and embodiment 8, the present embodiment provides a sliding door. Similarly, a bottom on an outdoor side (the right shown in FIG. 14) of the sliding door frame 22 may also be provided with a cover 20. The cover 20 is provided with a guide rail for guiding a sliding screen door leaf.

### Embodiment 11

In the present embodiment, a reinforced steel 34 for improving structural strength is built in the profile main body 5 of the universal profile 3 and for reinforcing the side-hung door (as shown in FIGS. 7, 9 and 18). As shown in FIG. 7, the screws may also penetrate through the reinforced steel 34 while penetrating through the universal profiles 3 and the connecting hollow 13, thereby improving the anchoring strength again.

As shown in FIGS. 3, 9 and 18, the component slot 4 in the inner-side outer edge 6 of the universal profile 3 has a trapezoidal cross section to be also adaptive to most of auxiliary profiles and door-leaf accessories on the market. A rubber sealing strip 35 is affixed onto the component slot 4 for crimping and sealing the panel 2. The component slot 4 in the outer-side outer edge 7 of the universal profile 3 has an L-shaped or T-shaped cross section so as to be also adaptive to most of auxiliary profiles and door-leaf accessories on the market.

The above-mentioned descriptions are merely preferred specific implementations of the present invention. The protection scope of the present invention is not limited thereto. Any variations or replacements that can be readily envisioned by those skilled in the art are intended to fall within the protection scope of the present invention.

What is claimed is:

1. A door leaf, comprising:
a frame (1); and
a panel (2) which fits in the frame (1), wherein:
the frame (1) is formed by connecting a plurality of universal profiles (3) which include a vertically-disposed universal profile and a horizontally-disposed universal profile;
the vertically-disposed universal profile and the horizontally-disposed universal profile interconnect at a right angle;
the universal profile (3) is provided with a plurality of component slots (4) for connecting an auxiliary profile and for assembling a door-leaf accessory;
the universal profile (3) includes:
a profile main body (5);
a plurality of inner-side outer edges (6) which extend to two ends of the profile main body (5); and
a plurality of outer-side outer edges (7) which extend to the two ends of the profile main body (5);
the profile main body (5) has a hollow cross section;
the inner-side outer edge (6) has a hollow cross section;
the outer-side outer edge (7) has a hollow cross section;
the plurality of inner-side outer edges (6), which are symmetrically configured, and an end surface on one side of the profile main body (5) form an inner-side mounting channel (8);
the plurality of outer-side outer edges (7), which are symmetrically configured, and an end surface on an other side of the profile main body (5) form an outer-side mounting channel (9);
an inner side surface of the inner-side outer edge (6) is symmetrically provided with a component slot (4);
an inner side surface of the outer-side outer edge (7) is symmetrically provided with a component slot (4);
a cross section of the profile main body (5) of the vertically-disposed universal profile is a rectangle, wherein:
the rectangle's diagonals intersect at a central point O-1 of the profile main body (5);
a line of symmetry L-1 of the universal profile (3) passes through the central point O-1;
a plurality of first reinforcement ribs (51), which are symmetric with respect to the line of symmetry L-1, are configured inside the profile main body (5);
a hollow space within the profile main body (5) is compartmentalized, by the plurality of first reinforcement ribs (51), into two symmetric first cavities (61) and a second cavity (62) sandwiched by the two first cavities (61);
the plurality of outer-side outer edges (7) are symmetrically configured with respect to the line of symmetry L-1;
a plurality of second reinforcement ribs (52) are symmetrically configured inside a hollow space within the plurality of outer-side outer edges (7);
the hollow space within the outer-side outer edge (7) is compartmentalized, by the second reinforcement rib (52), into a third cavity (63) and a fourth cavity (64) adjacent to the third cavity (63);
a fifth cavity (65) is configured in a hollow space in the inner-side outer edge (6);
the first reinforcement rib (51) is disposed in parallel to the line of symmetry L-1;
a plane on which the second reinforcement rib (52) is located is perpendicular to the line of symmetry L-1;
a cross-sectional area of the second cavity (62) is greater than a cross-sectional area of any one of the first cavity (61), the third cavity (63), the fourth cavity (64) and the fifth cavity (65);
a first depth along a direction in which an opening position of the inner-side mounting channel (8) extends to the central point O-1 is a depth of the inner-side mounting channel (8);
a second depth along a direction in which an opening position of the outer-side mounting channel (9) extends to the central point O-1 is a depth of the outer-side mounting channel (9);
the first depth is less than the second depth;
the second reinforcement rib (52) is located at a central position on the outer-side outer edge (7);
the outer-side mounting channel (9) is divided into an outer-side mounting channel outer end (91) and an outer-side mounting channel inner end (92) by the plane on which the second reinforcement rib (52) is located;
a width of the outer-side mounting channel outer end (91) is greater than a width of the outer-side mounting channel inner end (92); and
the outer-side mounting channel outer end (91) and the outer-side mounting slot inner end (92) are connected by an oblique transition segment (93) whose obliqueness transitions smoothly; and
a cross section of the profile main body (5) of the horizontally-disposed universal profile is a rectangle, wherein:
the rectangle's diagonals intersect at a central point O-2 of the profile main body (5);
a line of symmetry L-2 of the universal profile (3) passes through the central point O-2;
the inner-side outer edge (6) and the outer-side outer edge (7) which is on the same side as the inner-side outer edge (6) are interconnected and continuous;
a hollow structure formed by the inner-side outer edge (6) and the outer-side outer edge (7) is compartmentalized into a plurality of chambers by a plurality of third reinforcement ribs (53);
the inner-side mounting channel (8) is internally provided with a first bottom plate (94);
the outer-side mounting channel (9) is internally provided with a second bottom plate (95);
the first bottom plate (94), which is spaced apart from and disposed in parallel to one side of the profile main body (5), forms a sixth cavity (66);
the second bottom plate (95), which is disposed on an other side of the profile main body (5), forms a seventh cavity (67);
the second bottom plate (95), a middle portion of which bends towards the profile main body (5), is connected with a side of the profile main body (5) to form an integrated piece with the profile main body (5);
the integrated piece divides the seventh cavity (67) into two independent cavities; and
the two independent cavities formed by the seventh cavity (67) are symmetrically disposed with respect to the line of symmetry L-2.

2. The door leaf in claim 1, wherein:
a width of the outer-side outer edge (7) on the vertically-disposed universal profile is greater than a width of the outer-side outer edge (7) on the horizontally-disposed universal profile; and
a depth of the outer-side mounting channel (9) on the vertically-disposed universal profile is greater than a depth of the outer-side mounting channel (9) on the horizontally-disposed universal profile.

3. The door leaf in claim 1, wherein the frame (1) is formed by connecting exactly a pair of the vertically-disposed universal profiles and exactly a pair of the horizontally-disposed universal profiles.

4. The door leaf in claim 1, wherein:
a plurality of centerline grooves are formed in a middle portion of an end surface on two sides of the universal profile (3);
the plurality of centerline grooves include a first centerline groove (10) and a first centerline groove (11);
the first centerline groove (10) is configured on the inner-side mounting channel (8); and
the first centerline groove (11) is configured on the outer-side mounting channel (9).

5. The door leaf in claim 1, wherein a reinforced steel (34) is built into the profile main body (5) of the universal profile (3) for improving structural strength.

6. The door leaf in claim 1, wherein the component slot (4) in the inner-side outer edge (6) of the universal profile (3) has a trapezoidal cross section.

7. The door leaf in claim 1, wherein a rubber sealing strip (35) is affixed onto the component slot (4) for crimping and sealing the panel (2).

8. The door leaf in claim 4, wherein the component slot (4) in the outer-side outer edge (7) of the universal profile (3) has a T-shaped cross section.

9. A side-hung door, comprising:
a side-hung door frame (14); and
the door leaf in claim 1 for connecting to and for matching the side-hung door frame (14), wherein:
one side of the door leaf is hinged to the side-hung door frame (14) through a hinge (15);
the frame (1) is formed by combining a pair of the horizontally-disposed universal profiles (3) and a pair of the vertically-disposed universal profiles (3);
the panel (2) is mounted into the frame (1) through the inner-side mounting channel (8);
the outer-side outer edge (7) of the horizontally-disposed universal profile (3) is in clamping connection to a leaf-edge sealing cover plate (16) through a functional slot (4); and
the outer-side outer edge (7) of the universal profile (3) which is hinged to the side-hung door frame (14) is in clamping connection to a leaf-edge sealing cover plate (16) through a component slot (4).

10. The side-hung door in claim 9, wherein:
the side-hung door includes a matching pair of the door leaves;
a pair of the outer-side outer edges (7) on the universal profiles (3) of the matching pair of the door leaves are meant to meet each other when the side-hung door is closed;
a first one of the pair of the outer-side outer edges (7) is connected to a leaf-edge sealing cover plate (16) through a component slot (4) that is provided on the first one of the pair of the outer-side outer edges (7); and
a second one of the pair of the outer-side outer edges (7) is connected to a astragal (17) through a component slot (4) that is provided on the second one of the pair of the outer-side outer edges (7).

11. The side-hung door in claim 10, wherein:
the leaf-edge sealing cover plate (16) is in clamping connection with the universal profile (3);
a middle portion of the leaf-edge sealing cover plate (16) is provided with a side-hung door lock (18);
the astragal (17) is fixedly screwed to the door leaf; and
a middle portion of the astragal (17) is provided with a universal latch (19) to match the side-hung door lock (18).

12. The side-hung door in claim 9, wherein one side of a bottom of the side-hung door frame (14) is provided with a cover (20).

13. The side-hung door in claim 12, wherein an elastic sealing strip (21) is provided on a side surface of the cover (20) which is adjacent to the door leaf.

14. A sliding door, comprising:
a sliding door frame (22); and
a plurality of the door leaves in claim 1 which are in sliding fit with the sliding door frame (22), wherein:
the door leaf is slidably disposed on the sliding door frame (22);
the frame (1) is formed by combining a pair of the horizontally-disposed universal profiles (3) and a pair of the vertically-disposed universal profiles (3);
the panel (2) is mounted into the frame (1) through the outer-side mounting channel (9);
a top portion of the sliding door frame (22) is provided with a limiting track (23) which faces vertically downwards;
the outer-side outer edge (7) of the horizontally-disposed universal profile (3), which is on an upper end of the door leaf, is provided with a limiting channel (24) to match the limiting track (23);
the limiting channel (24), which is mounted in the outer-side mounting channel (9), is in sliding fit with the limiting track (23);
a bottom portion of the sliding door frame (22) is provided with a sliding track (25) which faces vertically upwards;
the outer-side outer edge (7) of the horizontally-disposed universal profile (3), which is on a lower end of the door leaf, is provided with a plurality of rollers (26) to match the sliding track (25); and
the plurality of rollers (26), which are mounted in the outer-side mounting channel (9), are in sliding fit with the sliding track (25).

15. The sliding door in claim 14, wherein:
a portion of the vertically-disposed universal profile (3) which engages the sliding door frame (22) when the sliding door is closed is in clamping connection with a leaf-edge sealing cover plate (16) through a component slot (4); and
a portion of the vertically-disposed universal profile (3) which engages a vertically-disposed universal profile of an adjacent door leaf when the sliding door is closed is in clamping connection with a limiting profile (27) through a component slot (4).

16. The sliding door in claim 15, wherein:
the limiting profile (27), which is L-shaped, includes:
an end cap (28) which is in clamping connection with a component slot (4); and
a limiting strip (29) which extends to a gap between an adjacent pair of the door leaves;
a pair of the limiting profiles (27) between the adjacent pair of the door leaves work together to control the adjacent pair of the door leaves to slide synchronously;
the limiting strip (29) is provided with a specialized component slot (4);
the limiting strip (29) is connected to a first sealing strip (30) and to a second sealing strip (31) through the specialized component slot (4);
the first sealing strip (30) faces towards the adjacent pair of the door leaves; and
the second sealing strip (31), which faces towards the limiting profile (27), seals a gap between the pair of the limiting profiles (27).

17. The sliding door in claim 13, wherein the end cap (28) and the limiting strip (29) are configured on an integrated piece.

18. The sliding door in claim 14, wherein:
a third sealing strip (32) is in clamping connection with a component slot (4) on the outer-side outer edge (7) of the universal profile (3) on the top portion of the sliding door frame (22);
the third sealing strip (32) fits the limiting track (23) for sealing purposes;
a fourth sealing strip (33) is in clamping connection with a component slot (4) on the outer-side outer edge (7) of the universal profile (3) on the bottom portion of the sliding door frame (22); and
the fourth sealing strip (33) fits the sliding track (25) for sealing purposes.

19. The sliding door in claim 14, wherein a cover (20) is provided on one side of the bottom portion of the sliding door frame (22).

20. The sliding door in claim 19, wherein the cover (20) is provided with a guide rail for guiding a sliding screen door leaf.
